(19) United States
(12) Patent Application Publication
(10) Pub. No.: US 2005/0253802 A1
(43) Pub. Date: Nov. 17, 2005

(54) Gyricon media using amorphous silicon thin film transistor active matrix arrays and a refresh method for the same

(76) Inventor: Charles A. Wright, Fowlerville, MI (US)

Correspondence Address: PILLSBURY WINTHROP SHAW PITTMAN, LLP, P.O. BOX 10500, MCLEAN, VA, 22102, US

(21) Appl. No.: 10/845,712

(22) Filed: May 14, 2004

(51) Int. Cl. G09G 3/34

(52) U.S. Cl. 345/107

(57) ABSTRACT

A gyricon medium comprising amorphous silicon thin film transistor active matrix arrays and a method of refreshing a gyricon active matrix display. The method involves the use of field effect instead of current flow in altering the orientation of rotary balls in a gyricon medium, thereby emulating the high brightness and contrast characteristics of paper in a low-power display.

### FIELD OF INVENTION

The present invention is generally related to gyricon media. More particularly, the present invention is related to gyricon media using amorphous silicon thin film transistor active matrix arrays and a method of refreshing a gyricon active matrix display.

### BACKGROUND OF INVENTION

Gyricon displays, also known as electrically twisting-ball displays or rotary ball displays, have numerous advantages over conventional electrically addressable visual displays, such as LCD and CRT displays. In particular, they are suitable for viewing in ambient light, retain an image indefinitely in the absence of an applied electric field, and can be made lightweight, flexible, foldable, and with many other familiar and useful characteristics of ordinary writing paper. Thus, at least in principle, they are suitable both for display applications and for so-called electric paper or interactive paper applications, in which they serve as an electrically addressable, reuseable (and thus environmentally friendly) substitute for ordinary paper. For further advantages of the gyricon, see U.S. Pat. No. 5,389,945, incorporated by reference hereinabove.

An exemplary prior art gyricon display 5 is shown in side view in FIG. 1. Bichromal (half white, half black) balls 10 are disposed in an elastomer substrate 20 that is swelled by dielectric fluid (not shown) creating cavities 30 in which the balls 10 are free to rotate. The balls 10 are electrically dipolar in the presence of the fluid and so are subject to rotation upon application of an electric field, as by matrix-addressable electrodes 40 and 43. The electrode 43 closest to upper surface 45 is preferably transparent. An observer at 50 sees an image formed by the black and white pattern of the balls 10 as rotated to expose their black or white faces (hemispheres) to the upper surface 45 of substrate 20.

U.S. Pat. No. 4,126,854 titled “Twisting Ball Panel Display” issued Nov. 21, 1978, and U.S. Pat. No. 4,143,103 titled “Method Of Making A Twisting Ball Display”, issued Mar. 6, 1979, both by Sheridon, describe a twisting rotating element (or “Gyricon”) display that comprises bichromal rotating elements contained in liquid-filled spherical cavities and embedded in an elastomer medium. One segment of the bichromal rotating elements has a larger electrical charge in contact with the liquid and in the presence of the electrical field than the other segment. Thus, for a given polarity of applied electrical field, one segment will rotate toward and be visible to an observer of the display. Applying the opposite polarity of electrical field will cause the rotating element to rotate and present the other segment to be seen by the observer.

U.S. Pat. No. 4,143,103 describes the response of the bichromal rotating element to the applied electrical field as a threshold response. That is, as the external field is increased, the bichromal rotating element remains stationary in position, until a threshold voltage is reached, at which time the rotating element starts to rotate from its initial position. The amount of rotation increases with an increasing electrical field until a 180 degree rotation can be achieved. The value of the external field that causes a 180 degree rotation is called the full addressing voltage.

The response pattern of the bichromal rotating element to an external electrical field determines the types of addressing that may be used to create images on the Gyricon display. There are known in the art three types of addressing schemes for displays. The first of these is active matrix addressing (described in more detail below), the second type is passive matrix addressing and the third type consists of a linear array of addressing electrodes in the form of a bar that can be moved over the surface of the display medium as described in U.S. Pat. No. 6,147,791, the contents of which are incorporated by reference herein.

Active matrix addressing is commonly used in conventional Active Matarix Liquid Crystal Displays (AMLCDs). As described in U.S. Pat. No. 5,748,268, a typical AMLCD comprises a sealed, relatively thin, transparent container (liquid crystal cell) holding liquid crystal material. On one side of the container (the active substrate) there is a matrix of relatively small (on the order of 100 microns square) pads of transparent conductive material, each representing an addressable element (pixel) of the display. Each one of the pads is connected to a variable source of voltage. The other (passive) substrate contains a uniform coating of transparent conductive material which is connected to a fixed voltage, typically ground. In addition, a polarizer is located on each side of the liquid crystal cell.

When a voltage is applied to an active pad it creates an electric field across the liquid crystal material in the gap between the active pad and the passive substrate conductive coating which is fixed at the set potential. This changes the polarization shift introduced to polarized light traveling through the affected portion of the liquid crystal cavity. This, in turn, changes the amount of light passing through the exit polarizer in the region of that pixel. Accordingly, the brightness of each pixel is controlled by the applied voltage.

A typical display screen may include some million pixel pads. Multiplexing schemes make it possible to address each pad separately. Typically, each pad has an associated “pixel transistor” which permits it to store a predetermined voltage between refresh times. Each transistor drain (or source) in a column of pixel transistors is connected with a driver element through a column electrode, while its source (or drain) is connected to the pixel pad. Likewise, each transistor gate in a row of pixel transistors is connected with a driver element through a row electrode.

Devices which manipulate voltages on the row and column electrodes are generally known as “drivers” and are typically discrete elements, attached to the AMLCD at the periphery of the screen, outside of the visible screen area. Conventional methods for forming the necessary grid of transistor switches rely on amorphous silicon (a-Si) as the semiconductor medium. The operating characteristics of a-Si transistors are such that these devices can provide only limited drive current and bandwidth, due to poor device mobility. Alternative semiconductor media have been investigated which have higher mobility and which therefore could permit the integration of row and column drivers onto the AMLCD active substrate. Polycrystalline silicon (p-si) and single crystal silicon (x-Si) have been used in this manner, and AMLCDs with integral drivers have been demonstrated.

Improved thin film transistors (TFTs) fabricated from amorphous silicon or polysilicon are described in two patents granted to Wakai et al., U.S. Pat. Nos. 5,032,883 and 5,229,644; as well as U.S. Pat. No. 5,177,577, granted to Taniguchi et al.; and patent granted to Kaneko et al., U.S. Pat. No. 5,166,816. Thin active matrix displays utilizing TFTs are described in U.S. Pat. No. 5,650,637. As described in the same patent, when a TFT is used in an active matrix panel, each TFT controls application of the voltage of the data signals to the liquid crystal material. While the contrast and display characteristics of a liquid crystal display device generally improves in bright light, the same light simultaneously deteriorates the TFT display performance, due to the increase in OFF current caused by light. Therefore, the TFTs have this disadvantage when used in a liquid crystal display device as a switching element.

There is a need, therefore, to find a means for taking advantage of the superior aspects of the active matrix display technology using TFTs while at the same time improving the image displaying characteristics by advantageously employing the superior optical characteristics of the Gyricon medium.

### SUMMARY OF INVENTION

The present invention provides the use of amorphous silicon thin film transistor active matrix arrays in displaying images in a gyricon medium. An aspect of the present invention involves the use of amorphous field effect transistors to alter the orientation of rotary balls in a gyricon (meaning rotating imagery) medium in order to display desired icons comprising letters, figures or pictures. An embodiment comprising an active matrix array coupled with gyricon provides high brightness and contrast comparable to paper and in a low-power display environment.

An embodiment of the present invention involves a gyricon medium configured to operate with active matrix arrays. A gyricon medium has two opposing surfaces. An electrode forms a first plate disposed over one of the two opposing surfaces. A matrix of thin film transistors (TFTs) are disposed over the other opposing surface. The conductors of the matrix of TFTs form a second plate sequestering the gyricon medium betwixt the two plates. A voltage potential applied across the medium using the first and second plates causes the gyricon medium to change state.

An aspect of an embodiment provides an electro-optical composite. The composite comprises a material having a plurality of components. At least one component is capable of being set into motion by electromotive forces. The component comprises at least two portions, each portion having an associated optical characteristic. An electrode is disposed over a surface of the material, the material having two opposing surfaces. And, a matrix of thin film transistors are disposed over the other opposing surface of the material. Thin film transistors control the electro-optical properties of the composite.

Another embodiment involves a gyricon active matrix assembly comprising a transmissive electro-optical device including a plurality of gyricon components, and a plurality of field effect transistors arranged to provide data signals to the plurality of gyricon components.

Still another embodiment of the present invention provides a method of using amorphous silicon thin film transistors in operating a gyricon active matrix display. The method involves providing a gyricon active matrix display having an array of field effect transistors (FETs). The matrix is initialized and refreshed by applying voltage to all conductors of the array of FETs simultaneously, thus using the plate having the FETs as one of the two electrodes for impressing an electric field over the gyricon medium. In this manner the method obviates row by row scanning, thus speeding up the process of imaging.

### BRIEF DESCRIPTION OF DRAWINGS

FIG. 1 is a drawing showing a gyricon medium according to prior art.

FIG. 2 is a drawing showing the use of amorphous silicon thin film transistors in refreshing a monolayer of gyricon medium, according to the present invention.

FIGS. 3a and 3b is a drawing of an embodiment showing the altering of the state of an electrically switchable rotary ball in a gyricon medium using amorphous silicon thin film transistor active matrix array, according to the present invention.

FIG. 4a is a drawing of an aspect of an embodiment showing gyricon display elements including thin film resistors in an active matrix array, according to the present invention.

FIG. 4b is a drawing of an aspect of an embodiment showing a circuit diagram of a gyricon display element, according to the present invention.

### DETAILED DESCRIPTION

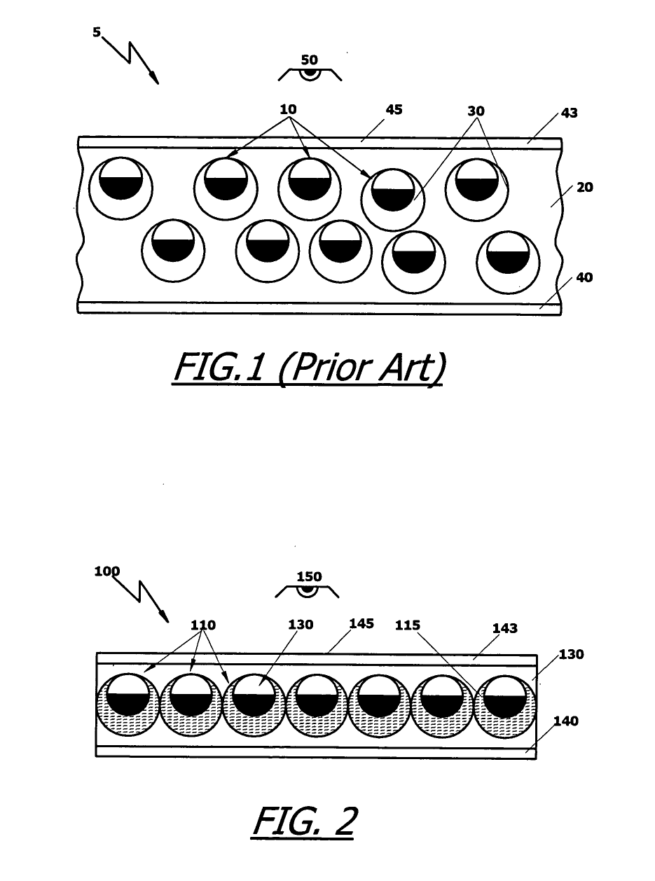

Referring now to the drawings, FIG. 2 is an illustration of an embodiment of a gyricon display 100 of the present invention utilizing a gyricon medium for displaying icons of various shapes and forms. The gyricon medium comprises an expandable fluid 120, preferably elastomeric in nature, in which bichromal balls 110 are formed by swelling the expandable fluid with a dielectric fluid 115. The dielectric fluid forms cavities 130 in which balls 110 are free to rotate. Gyricon medium is contained between two panels 140 and 143 that form the two lateral and opposing surfaces of the display. The display is hermetically sealed around the edges of the two panels, and the viewable surface of the display is transparent to the gyricon medium contained therein. The medium becomes viewable when the electro-optical properties of the medium is revealed as the bichromal rotary balls respond to an electric field, according to the present invention.

In an aspect of an embodiment of the present invention, it is preferred that the balls are placed as close to one another as possible in a monolayer in order to form a thin gyricon medium. Preferably, balls 110 are of uniform diameter and situated at a uniform distance from upper surface 145. It will be appreciated that the arrangement of balls 110 and cavities 130 in display 100 minimizes both the center-to-center spacing and the surface-to-surface spacing between neighboring bichromal balls.

Balls 110 are electrically dipolar in the presence of the dielectric fluid and so are subject to rotation upon application of an electric field, as by matrix-addressable electrodes 140 and 143. The electrode 143 closest to upper surface 145 is preferably transparent. An observer at 150 sees an image formed by the black and white pattern of the balls 110 as rotated to expose their black or white hemispheres to the upper surface 145 of medium 120.

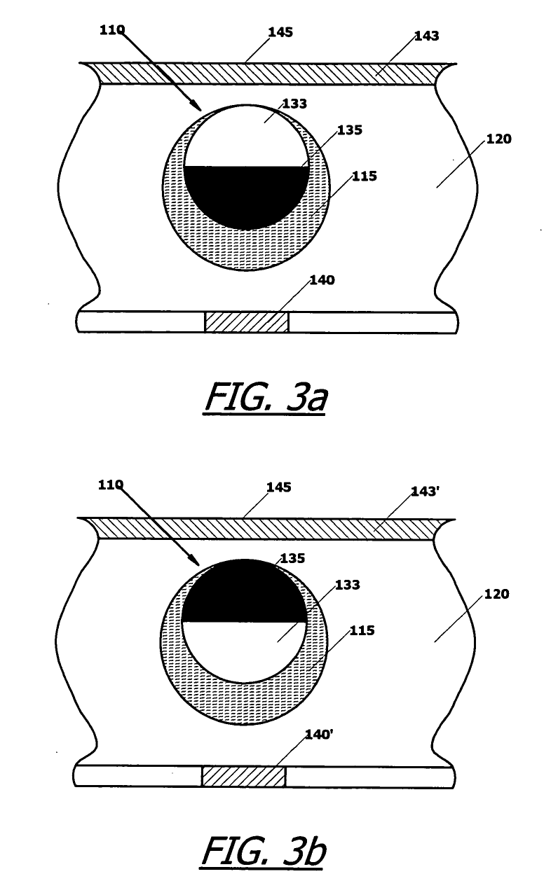

In one embodiment, the electric field is affected by incorporating the field effect transistors (FETs) of an active matrix configuration into the gyricon medium of the present invention. In an aspect of the embodiment, electrodes that manipulate or drive the rotary balls of the gyricon medium are arranged in a matrix of FETs. As schematically shown in FIGS. 3a and 3b, the FETs are formed on a lower transparent panel 140 while another transparent panel is formed as the upper panel 143. The gyricon medium 120 is sealed between the two panels 140 and 143. It is preferred that the upper panel comprises a transparent electrode material, including indium oxide, tin oxide, indium-tin oxide (ITO), or the like to be used as the display driving electrode, thus yielding a transparent-type display panel. In operation, an external selecting circuit selects some of the gyricon driving elements and each associated rotary ball in the medium is oriented accordingly to display the resulting iconic figures, including alpha-numeric characters. In FIG. 3b, the polarity of plates 140′ and 143′ are reversed relative to the polarity in FIG. 3a, as indicated by the primed reference numerals, and hence the rotary ball 110 is inverted to expose its black hemisphere instead of the white half. It will be understood by those skilled in the art that the orientation of rotary ball 110 and hence the positions of the “black” and “white” portions of the ball can be varied depending upon the levels of voltage impressed between plates 140′ and 143′. It will also be understood that the terms “black” and “white” are being used here to distinguish the two different hemispheres of the ball, and that other color combinations may also be used.

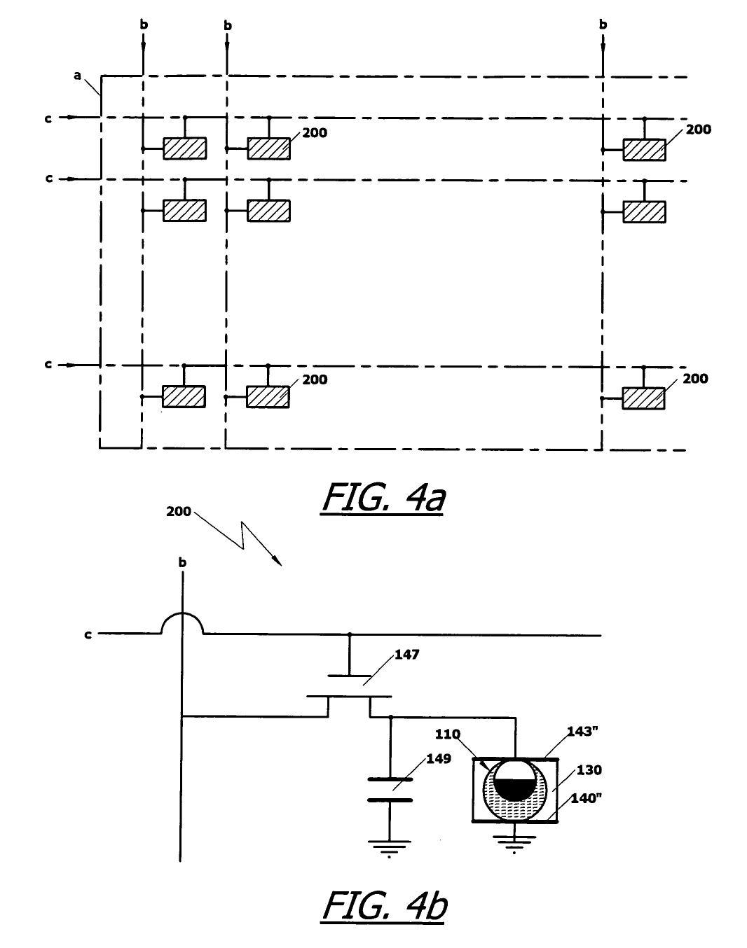

FIGS. 4a and 4b illustrate display elements utilizing FETs as switching elements in an active matrix display panel, according to another aspect of the present invention. FIG. 4a shows the matrix-type arrangement of gyricon driving elements formed on a lower substrate on which EFTs are formed. A display region is surrounded by a boundary line a, wherein a plurality of gyricon driving elements 200 are arranged in matrix format. A data signal line b and a timing signal line c are connected to each gyricon driving element 200. FIG. 4b represents a construction of each gyricon driving element 200. Gyricon medium 130 includes a gyricon driving electrode 140″ corresponding to each element 200 and has an opposed electrode 143″ formed on the upper plate. A thin film transistor FET 147 controls the input of a data signal to gyricon medium 130 containing the rotary ball 110. A capacitor 149 is used for storing the data signals and it is not required if the capacitance of the gyricon medium material is large enough. When a FET is used as a switching element in an active matrix panel, it selects the data signal to be applied to the gyricon medium. The FET controls the application of data signal voltage to the gyricon medium. In order to obtain high display performance, a thin film transistor, i.e., field effect transistor (FET) is required to have the characteristics that when the FET is ON, it permits enough current to flow to charge the associated capacitor, and that when the FET is OFF, it exhibits insignificant current leakage.

Display performance, according to the present invention, is enhanced through enabling the gyricon medium to have an all white reflection facing away from the thin film transistor, or FET. Also, a refresh sequence of alternating between all black and then all white states help cause the final displayed image to have a higher contrast ration than there would be in performing an image write the absence of black/white refresh. It is preferred that the black/white refresh culminates in all white viewable medium. This procedure essentially initializes the process for writing an image into the gyricon medium. Conventionally, in an active matrix environment, all black or all white image writing would have to be scanned one row after another.

Instead of row by row scanning, an embodiment of the present invention provides a gyricon medium with rotary balls which can change state—i.e., rotary balls turning, or switching from black to white, and vice versa—in its entirety when exposed to an electric field, rather than requiring an electric current. According to the present invention, the row and column conductors of an active matrix configuration (for example, conductors c and b in FIG. 4a) can be used as a single plate whereby a voltage potential impressed across the intervening gyricon medium between the conductor plate and the opposing ITO plate (140 and 143 in FIG. 3a, for example) will cause the gyricon medium to change state through the action of the rotary ball in the medium (as seen in comparative inverted states between FIGS. 3a and 3b). By controlling polarity across the gyricon medium, the viewable color state seen through the transparent surface 145 can also be controllably changed.

Though these numerous details of the disclosed embodiments are set forth here to provide an understanding of the present invention, it will be obvious, however, to those skilled in the art that these specific details need not be employed to practice the present invention. At the same time, it will be evident that the same embodiments may be employed in other similar inventive steps that are too many to cite, such as using cylindrical or other shapes in place of the spherical balls of the gyricon medium.

While the invention has been particularly shown and described with reference to particular embodiments, those skilled in the art will understand that various changes in form and details may be made without departing form the spirit and scope of the invention.

1. A gyricon medium configured to operate with active matrix arrays, comprising:
a gyricon medium having two opposing surfaces;
an electrode forming a first plate disposed over one of the two opposing surfaces; and
a matrix of thin film transistors (TFTs) disposed over the other opposing surface;
wherein conductors of the matrix of TFTs form a second plate sequestering the gyricon medium betwixt the two plates.

2. The gyricon medium according to claim 1, wherein the gyricon medium comprises electrically switchable rotary balls.

3. The gyricon medium according to claim 2, wherein each of the rotary balls comprises at least two portions, each portion having an associated optical characteristic that signal change of state of the rotating ball.

4. The gyricon medium according to claim 2, wherein each of the rotary balls has anisotropy for providing and electrical dipole moment that responds to an electric field by rotating the ball.

5. The gyricon medium according to claim 1, wherein the first plate comprises indium oxide, tin oxide or indium-tin oxide (ITO).

6. The gyricon medium according to claim 1, wherein a voltage potential applied across the medium using the first and second plates causes the gyricon medium to change state.

7. An electro-optical composite comprising:
a material having a plurality of components;
at least one component capable of being set into motion by electromotive forces, the component comprising at least two portions, each portion having an associated optical characteristics;
an electrode disposed over a surface of the material, the material having two opposing surfaces; and
a matrix of thin film transistors disposed over the other opposing surface of the material.

8. The electro-optical composite according to claim 7, wherein the material comprises a gyricon medium.

9. The electro-optical composite according to claim 7, wherein the component capable of being set into motion comprises a rotary ball having an orientation in a cavity filled with liquid.

10. The electro-optical composite according to claim 7, wherein at least one of the two portions has a reflective optical characteristic and the other has an absorptive optical characteristic.

11. The electro-optical composite according to claim 7, wherein the electrode comprises indium oxide, tin oxide or indium-tin oxide (ITO).

12. The electro-optical composite according to claim 7, wherein the thin film transistors controls the orientation of the ball in the cavity.

13. A gyricon active matrix assembly comprising:
a transmissive electro-optical device including a plurality of gyricon components; and
a plurality of field effect transistors arranged to provide data signals to the plurality of gyricon components.

14. The gyricon active matrix assembly according to claim 13, wherein the gyricon components comprise a transparent medium.

15. The gyricon active matrix assembly according to claim 13, wherein the gyricon components comprise at least one electrically switchable rotary ball.

16. The gyricon active matrix assembly according to claim 15, wherein the rotary ball comprises at least two portions, each portion having an associated optical characteristic that signal change of state of the rotating ball.

17. The gyricon active matrix assembly according to claim 13, wherein the rotary ball has anisotropy for providing and electrical dipole moment that responds to an electric field.

18. The gyricon active matrix assembly according to claim 13, wherein the field effect transistors provide the electrical field for rotary ball to respond.

19. A method of using amorphous silicon thin film transistors in operating a gyricon active matrix display, comprising the steps of:
providing a gyricon active matrix display having an array of field effect transistors (FETs);
initializing the matrix display;
performing alternating refresh sequence; and
impressing voltage to all conductors of the array of FETs simultaneously.

20. The method of operating a gyricon active matrix display according to claim 19, wherein the gyricon comprises a transparent medium having electrically switchable rotatable balls that orient themselves in accordance with an electric field that is imposed on them by an array of field effect transistors.

21. The method of operating a gyricon active matrix display according to claim 19, wherein the initializing the matrix display comprises applying a voltage across the display to provide an all white reflection facing away from the FETs.
